(19) United States
(12) Patent Application Publication
(10) Pub. No.: US 2025/0378982 A1
(43) Pub. Date: Dec. 11, 2025

(54) COIL DEVICE

(71) Applicant: Panasonic Intellectual Property Management Co., Ltd., Osaka (JP)

(72) Inventors: Takeya OKUNO, Nara (JP); Shinji UJITA, Osaka (JP); Kenichiro TANAKA, Hyogo (JP)

(21) Appl. No.: 18/877,135

(22) PCT Filed: May 9, 2023
(86) PCT No.: PCT/JP2023/017380

§ 371 Date: Dec. 19, 2024

(30) Foreign Application Priority Data
Jul. 19, 2022 (JP) 2022-114612

(51) Int. Cl. H01F 27/08; H01F 27/02; H01F 27/24; H01F 27/29

(52) U.S. Cl. CPC H01F 27/08; H01F 27/027; H01F 27/24; H01F 27/29

(57) ABSTRACT

A coil device includes: a core including: a first base portion; a second base portion; a first leg portion disposed between the first and second base portions; a second leg portion disposed on a first side relative to the first leg portion; and a third leg portion disposed on a second side relative to the first leg portion; and a board including: a first through-hole, a second through hole, and a third through hole through which the first to third leg portions are respectively inserted; and a wiring portion. The second leg portion includes two leg pieces spaced apart to define a first space that is open toward the first leg portion. The wiring portion includes: a first coil portion surrounding the first through-hole; and a first heat dissipator positioned in the first space and electrically connected to the first coil portion.

### TECHNICAL FIELD

The present disclosure relates to a coil device.

### BACKGROUND ART

Conventionally, coil devices that include coil portions are known. As an example of a coil device, Patent Literature (PTL) 1 discloses a printed circuit board in which coil patterns are disposed on a plurality of unit boards and the coil patterns on the stacked unit boards are connected to form a coil component. In the printed circuit board disclosed in PTL 1, the coil patterns are partially wide so that one or more heat dissipation pattern portions are integrally disposed with the coil patterns.

### CITATION LIST

### Patent Literature

[PTL 1] Japanese Unexamined Patent Application Publication No. H7-086755

### SUMMARY OF INVENTION

### Technical Problem

However, there is a problem that the size of the printed circuit board according to PTL 1 increases.

The present disclosure has been conceived to solve such a problem. An object of the present disclosure is to provide a coil device that is capable of efficiently dissipating the heat generated in the coil portion while reducing an increase in size.

### Solution to Problem

A coil device according to one aspect of the present disclosure includes: a core that includes: a first base portion; a second base portion that is opposed to the first base portion; a first leg portion that is disposed between the first base portion and the second base portion; a second leg portion that is disposed between the first base portion and the second base portion, the second leg portion being disposed on a first side relative to the first leg portion in a first orthogonal direction that is orthogonal to an opposing direction in which the first base portion and the second base portion are opposed to each other; and a third leg portion that is disposed between the first base portion and the second base portion, the third leg portion being disposed on a second side relative to the first leg portion in the first orthogonal direction; and a board that includes: a first through-hole through which the first leg portion is inserted; a second through-hole through which the second leg portion is inserted; a third through-hole through which the third leg portion is inserted; and a wiring portion. The second leg portion includes two leg pieces that are spaced apart in a second orthogonal direction to define a first space that is open toward the first leg portion, the second orthogonal direction being orthogonal to the opposing direction and the first orthogonal direction, and the wiring portion includes: a first coil portion that surrounds the first through-hole; and a first heat dissipator that is positioned in the first space and is electrically connected to the first coil portion.

### Advantageous Effects of Invention

According to the present disclosure, it is possible to provide a coil device that is capable of efficiently dissipating the heat generated in the coil portion while reducing an increase in size.

### BRIEF DESCRIPTION OF DRAWINGS

FIG. 1 is a perspective view of a coil device according to Embodiment 1.

FIG. 2 is an exploded perspective view of the coil device illustrated in FIG. 1.

FIG. 3 is an exploded perspective view of a first coil portion of the coil device illustrated in FIG. 1.

FIG. 4 is a plan view of a portion of the coil device illustrated in FIG. 1.

FIG. 5 is a cross-sectional view taken along line V-V in FIG. 4.

FIG. 6 is an exploded perspective view of a coil device according to Embodiment 2.

FIG. 7 is a plan view of a portion of the coil device illustrated in FIG. 6.

FIG. 8 is a cross-sectional view taken along line VIII-VIII in FIG. 7.

FIG. 9 is a plan view of a portion of a coil device according to Embodiment 3.

FIG. 10 is a cross-sectional view taken along line X-X in FIG. 9.

FIG. 11 is a plan view of a portion of a coil device according to Embodiment 4.

FIG. 12 illustrates a temperature of a coil device according to a comparative example and a temperature of a coil device according to Example 1.

FIG. 13 illustrates a temperature of the coil device according to Example 1 and a temperature of a coil device according to Example 2.

### DESCRIPTION OF EMBODIMENTS

Hereinafter, embodiments of the present disclosure will be described with reference to the drawings. Each of the embodiments described below shows one specific example of the present disclosure. Accordingly, the numerical values, shapes, materials, structural elements, arrangement positions and connection forms of the structural elements, shown in the following embodiments are merely examples, and do not intend to limit the present disclosure. Therefore, among the structural elements in the following embodiments, structural elements that are not described in independent claims are described as optional structural elements.

Moreover, each drawing is a schematic view, and is not necessarily illustrated exactly. Therefore, the scale and the like do not necessarily match in each figure. In the drawings, substantially the same elements are denoted by the same reference numerals, and overlapping descriptions will be omitted or simplified.

### Embodiment 1

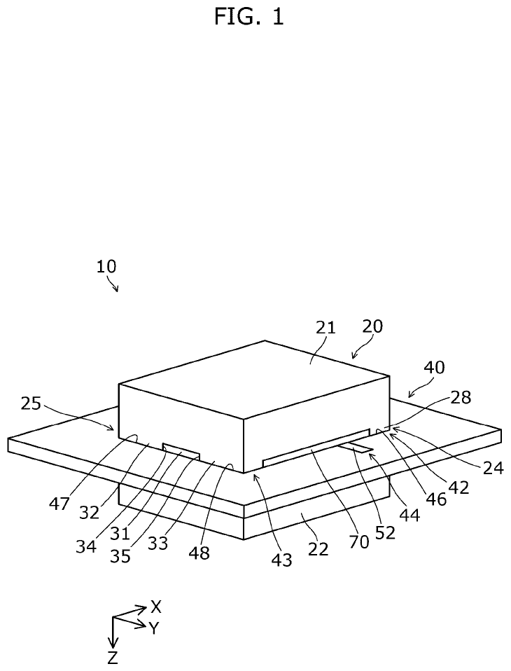

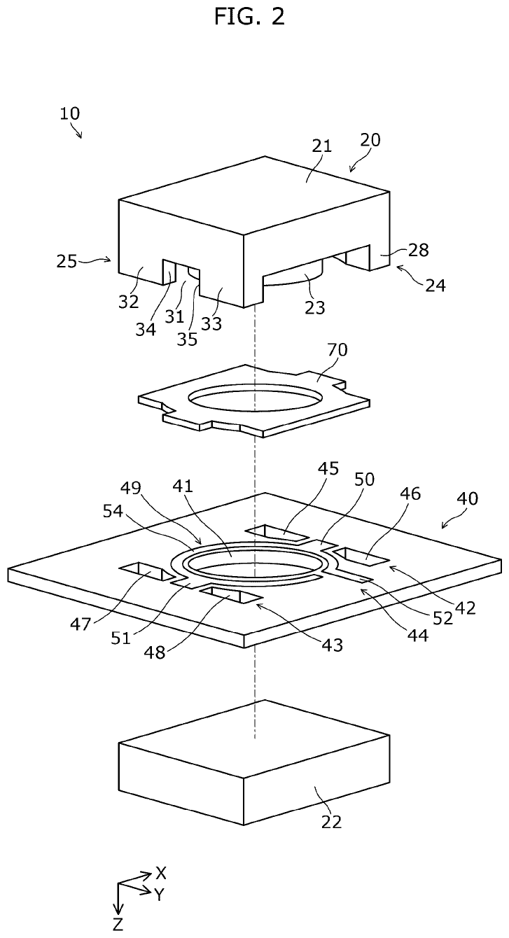

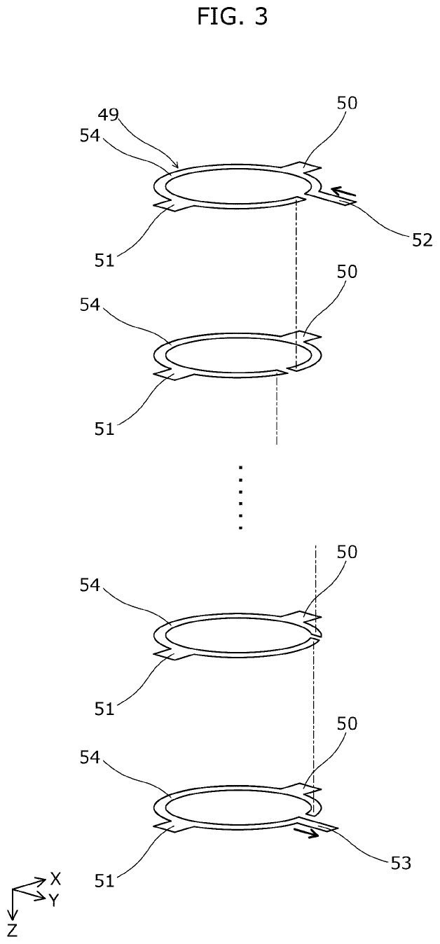

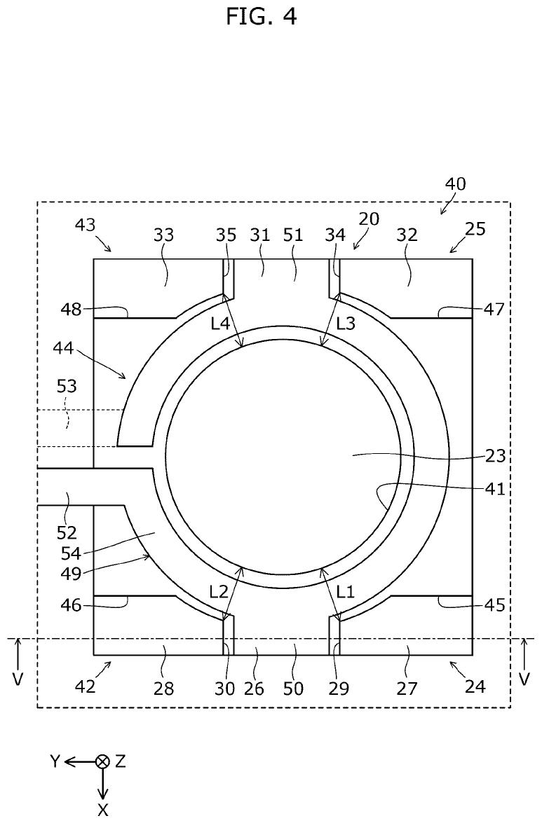

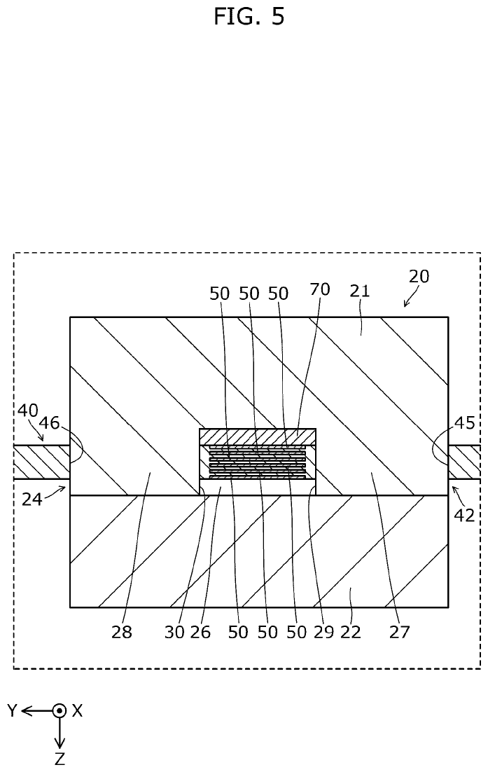

FIG. 1 is a perspective view of coil device 10 according to Embodiment 1. FIG. 2 is an exploded perspective view of coil device 10 illustrated in FIG. 1. FIG. 3 is an exploded perspective view of first coil portion 49 of coil device 10 illustrated in FIG. 1. FIG. 4 is a plan view of a portion of coil device 10 illustrated in FIG. 1. FIG. 5 is a cross-sectional view taken along line V-V in FIG. 4. In FIG. 4, illustrations of first base portion 21 and heat transfer member 70 are omitted.

As illustrated in FIG. 1 to FIG. 5, coil device 10 includes core 20, board 40, and heat transfer member 70. For example, coil device 10 is used for inductors or transformers.

Core 20 includes first base portion 21, second base portion 22, first leg portion 23, second leg portion 24, and third leg portion 25. Each of first base portion 21, second base portion 22, first leg portion 23, second leg portion 24, and third leg portion 25 is formed by a magnetic material, and core 20 is a magnetic core.

First base portion 21 is plate shaped. In the present embodiment, first base portion 21 is in a shape of a plate with a thickness direction that is an opposing direction (Z-axis direction in FIG. 1 and the like) in which first base portion 21 and second base portion 22 are opposed to each other. For example, first base portion 21 does not have to be plate shaped. Hereinafter, the opposing direction in which first base portion 21 and second base portion 22 are opposed to each other may be referred to simply as the opposing direction.

Second base portion 22 is opposed to first base portion 21. Second base portion 22 is plate shaped. In the present embodiment, second base portion 22 is in a shape of a plate with a thickness direction that is the opposing direction. For example, second base portion 22 does not have to be plate shaped.

First leg portion 23 is disposed between first base portion 21 and second base portion 22. In other words, when viewed from the opposing direction, first leg portion 23 overlaps with first base portion 21 and second base portion 22. When viewed from the opposing direction, first leg portion 23 entirely overlaps with first base portion 21 and second base portion 22.

First leg portion 23 is columnar with the opposing direction as the axial direction, and the outer shape of first leg portion 23 is circular when viewed from the opposing direction. In other words, first leg portion 23 is cylindrical with the opposing direction as the axial direction. For example, first leg portion 23 may be tubular with the opposing direction as the axial direction. Moreover, for example, the outer shape of first leg portion 23 when viewed from the opposing direction may be oval, polygonal, or elliptical.

First leg portion 23 is integrally formed with first base portion 21, extends from first base portion 21 toward second base portion 22, and is in contact with second base portion 22. For example, first leg portion 23 does not have to be in contact with second base portion 22. For example, first leg portion 23 may be integrally formed with second base portion 22, extend from second base portion 22 toward first base portion 21, and be in contact with first base portion 21. Moreover, for example, first leg portion 23 may be divided into two leg pieces in the opposing directions. It may be that one of the two leg pieces is integrally formed with first base portion 21 and extends from first base portion 21 toward second base portion 22, and the other of the two leg pieces is integrally formed with second base portion 22 and extends from second base portion 22 toward first base portion 21.

Second leg portion 24 is disposed between first base portion 21 and second base portion 22. In other words, when viewed from the opposing direction, second leg portion 24 overlaps with first base portion 21 and second base portion 22. In the present embodiment, when viewed from the opposing direction, second leg portion 24 entirely overlaps with first base portion 21 and second base portion 22.

Second leg portion 24 is disposed on a first side (positive X-axis side in FIG. 1, etc.) relative to first leg portion 23 in a first orthogonal direction (X-axis direction in FIG. 1, etc.) that is orthogonal to the opposing direction. In the following description, the first orthogonal direction that is orthogonal to the opposing direction may simply be referred to as the first orthogonal direction.

Second leg portion 24 includes two leg pieces 27 and 28 that are spaced apart from each other in a second orthogonal direction (Y-axis direction in FIG. 1, etc.) that is orthogonal to the opposing direction and orthogonal to the first orthogonal direction to define first space 26 that is open toward first leg portion 23. First space 26 is the space between two leg pieces 27 and 28.

Leg piece 27, which is one of two leg pieces 27 and 28, includes face 29 that is closer to the other leg piece 28. Face 29 is parallel to the opposing direction and parallel to the first orthogonal direction. Leg piece 28, which is the other of two leg pieces 27 and 28, includes face 30 that is closer to leg piece 27. Face 30 is parallel to the opposing direction and parallel to the first orthogonal direction. First space 26 is the space between face 29 and face 30. For example, each of face 29 and face 30 may be inclined with respect to the first orthogonal direction, curved with respect to the first orthogonal direction, or bent with respect to the first orthogonal direction.

In the first orthogonal direction, face 29 and face 30 are positioned on a first side relative to first coil portion 49, and first space 26 is positioned on the first side relative to first coil portion 49.

In the present embodiment, face 29 is connected to each of first base portion 21 and second base portion 22, face 30 is connected to each of first base portion 21 and second base portion 22, one end portion of first space 26 in the opposing direction is defined by second base portion 22, and the other end portion of first space 26 in the opposing direction is defined by first base portion 21.

In the present embodiment, first space 26 is also open at the opposite side from first leg portion 23. In other words, in the present embodiment, first space 26 penetrates second leg portion 24. Specifically, in the present embodiment, first space 26 penetrates second leg portion 24 in the first orthogonal direction.

Second leg portion 24 is integrally formed with first base portion 21, extends from first base portion 21 toward second base portion 22, and is in contact with second base portion 22. Specifically, each of two leg pieces 27 and 28 is integrally formed with first base portion 21, extends from first base portion 21 toward second base portion 22, and is in contact with second base portion 22. For example, second leg portion 24 does not have to be in contact with second base portion 22. Specifically, each of two leg pieces 27 and 28 does not have to be in contact with second base portion 22. For example, second leg portion 24 may be integrally formed with second base portion 22, extend from second base portion 22 toward first base portion 21, and be in contact with first base portion 21. Specifically, each of two leg pieces 27 and 28 may be integrally formed with second base portion 22, extend from second base portion 22 toward first base portion 21, and be in contact with first base portion 21. Moreover, for example, second leg portion 24 may be divided into two leg pieces in the opposing direction. It may be that one of the two leg pieces is integrally formed with first base portion 21 and extends from first base portion 21 toward second base portion 22, and the other of the two leg pieces is integrally formed with second base portion 22 and extends from second base portion 22 toward first base portion 21. Specifically, each of two leg portions 27 and 28 may be divided into two leg pieces in the opposing direction. It may be that one of the two leg pieces may be integrally formed with first base portion 21 and extends from first base portion 21 toward second base portion 22, and the other of the two leg pieces is integrally formed with second base portion 22 and extends from second base portion 22 toward first base portion 21.

Third leg portion 25 is disposed between first base portion 21 and second base portion 22. In other words, when viewed from the opposing direction, third leg portion 25 overlaps with first base portion 21 and second base portion 22. In the present embodiment, when viewed from the opposing direction, third leg portion 25 entirely overlaps with first base portion 21 and second base portion 22.

Third base portion 25 is disposed on a second side (negative X-axis side in FIG. 1, etc.) relative to first leg portion 23 in the first orthogonal direction.

Third leg portion 25 includes two leg pieces 32 and 33 that are spaced apart in the second orthogonal direction to define second space 31 that is open toward first leg portion 23. Second space 31 is the space between two leg pieces 32 and 33.

Leg piece 32, which is one of two leg pieces 32 and 33, includes face 34 that is closer to the other leg piece 33. Face 34 is parallel to the opposing direction and is parallel to the first orthogonal direction. Moreover, leg piece 33, which is the other one of two leg pieces 32 and 33, includes face 35 that is closer to leg piece 32. Face 35 is parallel to the opposing direction and is parallel to the first orthogonal direction. Second space 31 is the space between face 34 and face 35. Each of face 34 and face 35 may be inclined with respect to the first orthogonal direction, curved with respect to the first orthogonal direction, or bent with respect to the first orthogonal direction.

In the first orthogonal direction, face 34 and face 35 are positioned on a second side relative to first coil portion 49, and second space 31 is positioned on the second side relative to first coil portion 49.

In the present embodiment, face 34 is connected to each of first base portion 21 and second base portion 22, face 35 is connected to each of first base portion 21 and second base portion 22, one end portion of second space 31 in the opposing direction is defined by second base portion 22, and the other end portion of second space 31 in the opposing direction is defined by first base portion 21.

In the present embodiment, second space 31 is also open toward the opposite side from first leg portion 23. In other words, in the present embodiment, second space 31 penetrates third leg portion 25. Specifically, in the present embodiment, second space 31 penetrates third leg portion 25 in the first orthogonal direction.

Third leg portion 25 is integrally formed with first base portion 21, extends from first base portion 21 toward second base portion 22, and is in contact with second base portion 22. Specifically, each of two leg pieces 32 and 33 is integrally formed with first base portion 21, extends from first base portion 21 toward second base portion 22, and is in contact with second base portion 22. For example, third leg portion 25 does not have to be in contact with second base portion 22. Specifically, each of two leg pieces 32 and 33 does not have to be in contact with second base portion 22. Moreover, for example, third leg portion 25 may be integrally formed with second base portion 22, extend from second base portion 22 toward first base portion 21, and be in contact with first base portion 21. Specifically, each of two leg pieces 32 and 33 may be integrally formed with second base portion 22, extend from second base portion 22 toward first base portion 21, and be in contact with first base portion 21. Moreover, for example, third leg portion 25 may be divided into two leg pieces in the opposing direction. It may be that one of the two leg pieces is integrally formed with first base portion 21 and extends from first base portion 21 toward second base portion 22, and the other of the two leg pieces is integrally formed with second base portion 22 and extends from second base portion 22 toward first base portion 21. Specifically, each of two leg pieces 32 and 33 may be divided into two leg pieces in the opposing direction. It may be that one of the two leg pieces is integrally formed with first base portion 21 and extends from first base portion 21 toward second base portion 22, and the other of the two leg pieces is integrally formed with second base portion 22 and extends from second base portion 22 toward first base portion 21.

Shortest distances L1 and L2 from first leg portion 23 to each of two leg pieces 27 and 28 of second leg portion 24 are equal to shortest distances L3 and L4 from first leg portion 23 to each of two leg pieces 32 and 33 of third leg portion 25. In other words, shortest distances L1, L2, L3, and L4 are equal to one another. For example, shortest distances L1, L2, L3, and L4 do not have to be equal to one another.

In the first orthogonal direction, the dimension of first leg portion 23 is larger than the dimension of each of second leg portion 24 and third leg portion 25. For example, in the first orthogonal direction, the maximum dimension of first leg portion 23 is larger than the maximum dimension of each of second leg portion 24 and third leg portion 25.

Board 40 includes first through-hole 41, second through-hole 42, third through-hole 43, and wiring portion 44. For example, board 40 is fixed to core 20 via heat transfer member 70.

First through-hole 41 is a through-hole through which first leg portion 23 is inserted. First through-hole 41 penetrates board 40 in the opposing direction. The shape of first through-hole 41 viewed from the opposing direction corresponds to the outer shape of first leg portion 23 viewed from the opposing direction.

Second through-hole 42 is a through-hole through which second leg portion 24 is inserted. Second through-hole 42 penetrates board 40 in the opposing direction. Second through-hole 42 is provided on a first side relative to first through-hole 41 in the first orthogonal direction. Second through-hole 42 includes two through-holes 45 and 46 corresponding to two leg pieces 27 and 28. Through-hole 45, which is one of two through-holes 45 and 46, is a through-hole through which leg piece 27 is inserted, and through-hole 46, which is the other of two through-holes 45 and 46, is a through-hole through which leg piece 28 is inserted. The shape of through-hole 45 viewed from the opposing direction corresponds to the outer shape of leg piece 27 viewed from the opposing direction, and the shape of through-hole 46 viewed from the opposing direction corresponds to the outer shape of leg piece 28 viewed from the opposing direction.

Third through-hole 43 is a through-hole through which third leg portion 25 is inserted. Third through-hole 43 penetrates board 40 in the opposing direction. Third through-hole 43 is provided on a second side relative to first through-hole 41 in the first orthogonal direction. Third through-hole 43 includes two through-holes 47 and 48 corresponding to two leg pieces 32 and 33. Through-hole 47, which is one of two through-holes 47 and 48, is a through-hole through which leg piece 32 is inserted, and through-hole 48, which is the other of two through-holes 47 and 48, is a through-hole through which leg piece 33 is inserted. The shape of through-hole 47 viewed from the opposing direction corresponds to the outer shape of leg piece 32 viewed from the opposing direction, and the shape of through-hole 48 viewed from the opposing direction corresponds to the outer shape of leg piece 33 viewed from the opposing direction.

Wiring portion 44 includes first coil portion 49, a plurality of first heat dissipators 50, a plurality of second heat dissipators 51, first lead-out portion 52, and second lead-out portion 53.

First coil portion 49 is positioned outside first through-hole 41, surrounds first through-hole 41, and surrounds first leg portion 23 inserted into first through-hole 41. First coil portion 49 is wound so as to surround first through-hole 41. First coil portion 49 includes wiring patterns 54 disposed on board 40. For example, wiring patterns 54 are formed by a conductor such as copper. In the present embodiment, first coil portion 49 includes wiring pattern 54 disposed on a first main surface of board 40 closer to first base portion 21, wiring pattern 54 disposed on a second main surface of board 40 closer to second base portion 22, and one or more wiring patterns 54 disposed on one or more inner layers of board 40. Each of wiring patterns 54 is curved around the opposing direction. Wiring patterns 54 are stacked in the opposing direction. An insulating layer is disposed between two adjacent ones of the plurality of wiring patterns 54 in the opposing direction. Two of the plurality of wiring patterns 54 adjacent to each other in the opposing direction are electrically connected via via-conductors (not illustrated).

Each of the plurality of first heat dissipators 50 is a wiring pattern for dissipating the heat generated in first coil portion 49. Each of the plurality of first heat dissipators 50 is positioned in first space 26. Each of the plurality of first heat dissipators 50 is electrically connected to first coil portion 49. In the present embodiment, the plurality of first heat dissipators 50 are disposed so as to correspond to the plurality of wiring patterns 54, and include: first heat dissipator 50 disposed on the first main surface of board 40 closer to first base portion 21; first heat dissipator 50 disposed on the second main surface of board 40 closer to second base portion 22; and one or more first heat dissipators 50 disposed on one or more inner layers of board 40. Each of the plurality of first heat dissipators 50 is electrically connected to first coil portion 49 by being connected to the corresponding wiring pattern 54 of the plurality of wiring patterns 54. For example, one first heat dissipator 50 may be disposed instead of a plurality of first heat dissipators 50.

Each of the plurality of second heat dissipators 51 is a wiring pattern for dissipating the heat generated in first coil portion 49. Each of the plurality of second heat dissipators 51 is positioned in second space 31. Each of the plurality of second heat dissipators 51 is electrically connected to first coil portion 49. In the present embodiment, the plurality of second heat dissipators 51 are disposed so as to correspond to the plurality of wiring patterns 54, and include: second heat dissipator 51 disposed on the first main surface of board 40 closer to first base portion 21; second heat dissipator 51 disposed on the second main surface of board 40 closer to second base portion 22; and one or more second heat dissipators 51 disposed on one or more inner layers of board 40. Each of the plurality of second heat dissipators 51 is electrically connected to first coil portion 49 by being connected to a corresponding one of wiring patterns 54. For example, one second heat dissipator 51 may be provided instead of a plurality of second heat dissipators 51.

First lead-out portion 52 is a wiring pattern for a current flow to first coil portion 49. First lead-out portion 52 is disposed on the first main surface of board 40 closer to first base portion 21, is connected to wiring pattern 54 disposed on the first main surface, and extends in the second orthogonal direction from wiring pattern 54 between second leg portion 24 and third leg portion 25. For example, first lead-out portion 52 may be disposed on the second main surface of board 40 closer to second base portion 22, and may be connected to wiring pattern 54 disposed on the second main surface of board 40 closer to first base portion 21 via a via-conductor (not illustrated).

Second lead-out portion 53 is a wiring pattern for a current flow to first coil portion 49. Second lead-out portion 53 is disposed on the second main surface of board 40 closer to second base portion 22, is connected to wiring pattern 54 disposed on the second main surface, and extends in the second orthogonal direction from wiring pattern 54 between second leg portion 24 and third leg portion 25. For example, second lead-out portion 53 may be disposed on the first main surface of board 40 closer to first base portion 21 and may be connected to wiring pattern 54 disposed on the second main surface of board 40 closer to second base portion 22 via a via-conductor (not illustrated).

For example, a magnetic field can be generated by first coil portion 49 by causing current to flow from first lead-out portion 52 to second lead-out portion 53 (see thick arrows in FIG. 3). For example, current may flow from second lead-out portion 53 to first lead-out portion 52.

Heat transfer member 70 is disposed between first heat dissipator 50 and first base portion 21. In the present embodiment, heat transfer member 70 is in contact with first heat dissipator 50 disposed on the first main surface of board 40 closer to first base portion 21, and is in contact with first base portion 21.

Heat transfer member 70 is disposed between second heat dissipator 51 and first base portion 21. In the present embodiment, heat transfer member 70 is in contact with second heat dissipator 51 disposed on the first main surface of board 40 closer to first base portion 21, and is in contact with first base portion 21.

Heat transfer member 70 is disposed between first coil portion 49 and first base portion 21. In the present embodiment, heat transfer member 70 is in contact with wiring pattern 54 disposed on the first main surface of board 40 closer to first base portion 21, and is in contact with first base portion 21.

Heat transfer member 70 is a gap filler, and is disposed to fill the gap between board 40 and first base portion 21.

For example, heat transfer member 70 is made of resin or metal.

Coil device 10 according to Embodiment 1 includes: core 20 that includes: first base portion 21; second base portion 22 that is opposed to first base portion 21; first leg portion 23 that is disposed between first base portion 21 and second base portion 22; second leg portion 24 that is disposed between first base portion 21 and second base portion 22, second leg portion 24 being disposed on a first side relative to first leg portion 23 in a first orthogonal direction that is orthogonal to an opposing direction in which first base portion 21 and second base portion 22 are opposed to each other; and third leg portion 25 that is disposed between first base portion 21 and second base portion 22, third leg portion 25 being disposed on a second side relative to first leg portion 23 in the first orthogonal direction; and board 40 that includes: first through-hole 41 through which first leg portion 23 is inserted; second through-hole 42 through which second leg portion 24 is inserted; third through-hole 43 through which third leg portion 25 is inserted; and wiring portion 44. Second leg portion 24 includes two leg pieces 27 and 28 that are spaced apart in a second orthogonal direction to define first space 26 that is open toward first leg portion 23, the second orthogonal direction being orthogonal to the opposing direction and the first orthogonal direction, and wiring portion 44 includes: first coil portion 49 that surrounds first through-hole 41; and first heat dissipator 50 that is positioned in first space 26 and is electrically connected to first coil portion 49.

This enables the heat generated in first coil portion 49 to be dissipated via first heat dissipator 50 positioned in first space 26 and electrically connected to first coil portion 49. Therefore, it is possible to efficiently dissipate the heat generated in first coil portion 49, while reducing an increase in size of coil device 10.

Moreover, coil device 10 according to Embodiment 1, includes: heat transfer member 70 that is disposed between first heat dissipator 50 and first base portion 21.

This facilitates the transfer of the heat generated in first coil portion 49 to first base portion 21 via first heat dissipator 50 and heat transfer member 70. Therefore, it is possible to more efficiently dissipate the heat generated in first coil portion 49, while reducing an increase in size of coil device 10.

Moreover, in coil device 10 according to Embodiment 1, heat transfer member 70 is a gap filler.

This further facilitates the transfer of the heat generated in first coil portion 49 to first base portion 21 via first heat dissipator 50 and heat transfer member 70. Therefore, it is possible to more efficiently dissipate the heat generated in first coil portion 49, while reducing an increase in size of coil device 10.

In coil device 10 according to Embodiment 1, first coil portion 49 includes wiring pattern 54 that is disposed on a main surface of board 40 closer to first base portion 21, and first heat dissipator 50 is disposed on the main surface, and is connected to wiring pattern 54.

This facilitates an electrical connection between first heat dissipater 50 and first coil portion 49. Moreover, since first heat dissipator 50 is disposed on the main surface of board 40 closer to first base portion 21, the heat generated in first coil portion 49 can be easily dissipated via first heat dissipator 50. Therefore, it is possible to more efficiently dissipate the heat generated in first coil portion 49, while reducing an increase in size of coil device 10.

In coil device 10 according to Embodiment 1, third leg portion 25 includes two leg pieces 32 and 33 that are spaced apart in the second orthogonal direction to define second space 31 that is open toward first leg portion 23, and wiring portion 44 includes second heat dissipator 51 that is positioned in second space 31, second heat dissipator 51 being electrically connected to first coil portion 49.

This enables the heat generated in first coil portion 49 to be dissipated via second heat dissipator 51 positioned in second space 31 and electrically connected to first coil portion 49. Therefore, it is possible to more efficiently dissipate the heat generated in first coil portion 49, while reducing an increase in size of coil device 10.

Moreover, in coil device 10 according to Embodiment 1, shortest distance L1 and L2 between first leg portion 23 and each of two leg pieces 27 and 28 of second leg portion 24 is equal to shortest distance L3 and L4 between first leg portion 23 and each of two leg pieces 32 and 33 of third leg portion 25.

This makes the magnetic flux density of the magnetic field generated by first coil portion 49 more uniform.

Moreover, in coil device 10 according to Embodiment 1, in the first orthogonal direction, a dimension of first leg portion 23 is greater than each of a dimension of second leg portion 24 and a dimension of third leg portion 25.

This enables the heat generated in first coil portion 49 to be efficiently dissipated, while reducing an increase in size of coil device 10.

### Embodiment 2

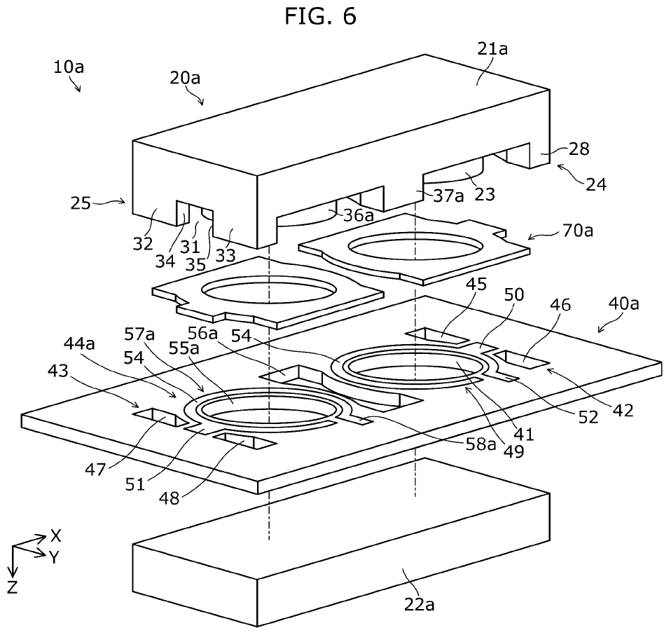

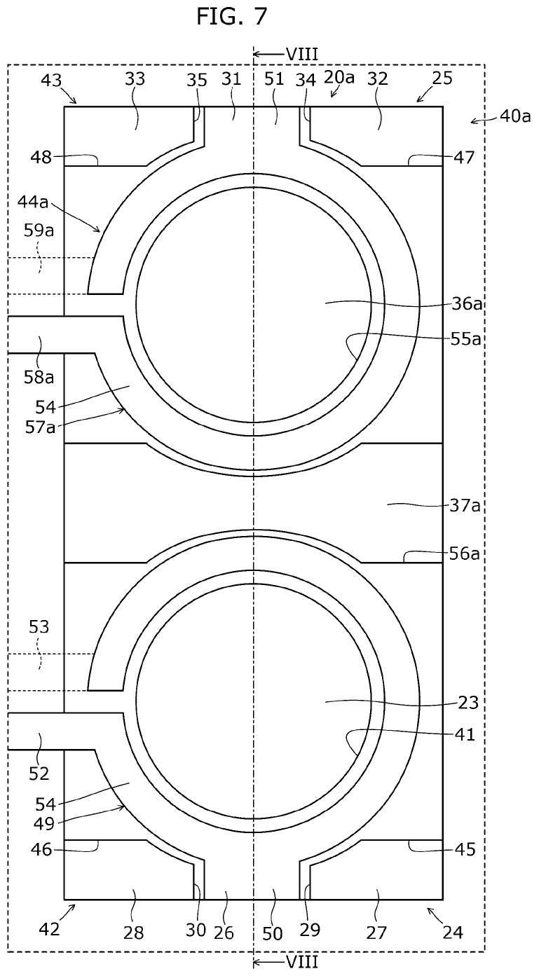

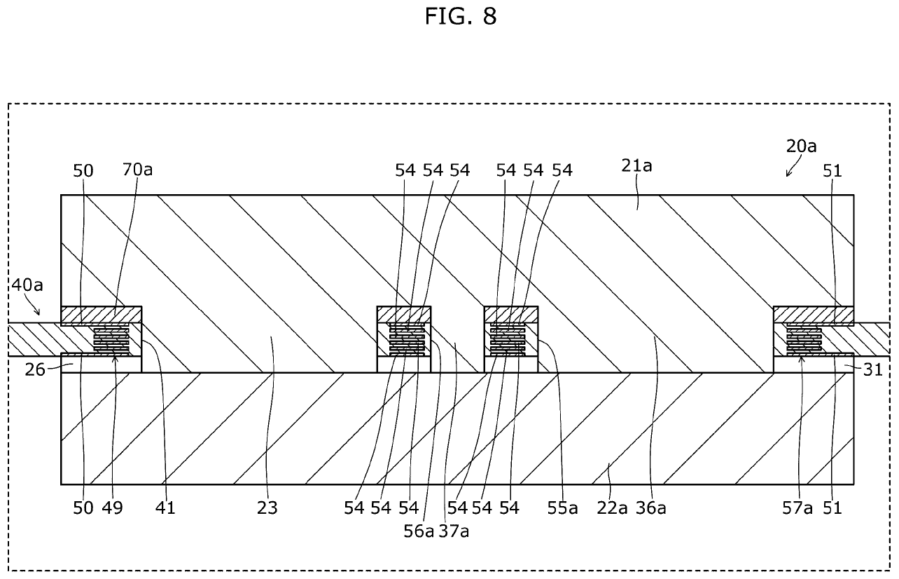

FIG. 6 is an exploded perspective view of coil device 10a according to Embodiment 2. FIG. 7 is a plan view of a portion of coil device 10a illustrated in FIG. 6. FIG. 8 is a cross-sectional view taken along line VIII-VIII in FIG. 7.

As illustrated in FIG. 6 to FIG. 8, coil device 10a includes core 20a, board 40a, and heat transfer member 70a. The differences from coil device 10 will mainly be described below.

Core 20a includes first base portion 21a, second base portion 22a, fourth leg portion 36a, and fifth leg portion 37a.

Fourth leg portion 36a is disposed between first base portion 21a and second base portion 22a. In other words, when viewed from the opposing direction, fourth leg portion 36a overlaps with first base portion 21a and second base portion 22a. When viewed from the opposing direction, fourth leg portion 36a entirely overlaps with first base portion 21a and second base portion 22a.

Fourth leg portion 36a is disposed between first leg portion 23 and third leg portion 25. Fourth leg portion 36a is aligned with first leg portion 23 in the first orthogonal direction. Since fourth leg portion 36a is identical to first leg portion 23 in shape, a detailed description of fourth leg portion 36a is omitted.

Third leg portion 25 is disposed on a second side relative to fourth leg portion 36a in the first orthogonal direction. Third leg portion 25 includes two leg pieces 32 and 33 that are spaced apart in the second orthogonal direction to define second space 31 that is open toward fourth leg portion 36a.

Fifth leg portion 37a is disposed between first base portion 21a and second base portion 22a. In other words, when viewed from the opposing direction, fifth leg portion 37a overlaps with first base portion 21a and second base portion 22a.

Fifth leg portion 37a is disposed between first leg portion 23 and fourth leg portion 36a in the first orthogonal direction.

Fifth leg portion 37a is integrally formed with first base portion 21a, extends from first base portion 21a toward second base portion 22a, and is in contact with second base portion 22a. For example, fifth leg portion 37a does not have to be in contact with second base portion 22a. Moreover, for example, fifth leg portion 37a may be integrally formed with second base portion 22a, extend from second base portion 22a toward first base portion 21a, and be in contact with first base portion 21a. Moreover, for example, fifth leg portion 37a may be divided into two leg pieces in the opposing direction. It may be that one of the two leg pieces is integrally formed with first base portion 21a and extends from first base portion 21a toward second base portion 22a, and the other of the two leg pieces is integrally formed with second base portion 22a and extends from second base portion 22a toward first base portion 21a.

The sum of the area of first leg portion 23 and the area of fourth leg portion 36a is greater than the sum of the area of second leg portion 24, the area of third leg portion 25, and the area of fifth leg portion 37a when viewed from the opposing direction.

Board 40a includes fourth through-hole 55a, fifth through-hole 56a, and wiring portion 44a.

Fourth through-hole 55a is a through-hole through which fourth leg portion 36a is inserted. Fourth through-hole 55a is disposed between first through-hole 41 and third through-hole 43. Fourth through-hole 55a is aligned with first through-hole 41 in the first orthogonal direction. Since fourth through-hole 55a is identical to first through-hole 41 in shape, a detailed description of fourth through-hole 55a is omitted.

Fifth through-hole 56a is a through-hole through which fifth leg portion 37a is inserted. Fifth through-hole 56a is disposed between first through-hole 41 and fourth through-hole 55a. Fifth through-hole 56a penetrates board 40a in the opposing direction. The shape of fifth through-hole 56a viewed from the opposing direction corresponds to the outer shape of fifth leg portion 37a viewed from the opposing direction.

Wiring portion 44a includes second coil portion 57a, first lead-out portion 58a, and second lead-out portion 59a.

Second coil portion 57a is positioned outside fourth through-hole 55a, surrounds fourth through-hole 55a, and surrounds fourth leg portion 36a inserted into fourth through-hole 55a. Second coil portion 57a is wound so as to surround fourth through-hole 55a. Since second coil portion 57a has the same configuration as first coil portion 49, a detailed description of second coil portion 57a is omitted.

In the present embodiment, first heat dissipator 50 is disposed only on the first main surface of board 40a closer to first base portion 21a and the second main surface of board 40a closer to second base portion 22a. For example, first heat dissipator 50 may be disposed on the inner layer of board 40a.

First heat dissipator 50 disposed on the first main surface of board 40a closer to first base portion 21a is connected to wiring pattern 54 of first coil portion 49 disposed on the first main surface. First heat dissipator 50 disposed on the second main surface of board 40a closer to second base 22a is connected to wiring pattern 54 of first coil portion 49 disposed on the second main surface.

In the present embodiment, second heat dissipator 51 is disposed only on the first main surface of board 40a closer to first base portion 21a and the second main surface of board 40a closer to second base portion 22a. For example, second heat dissipator 51 may be disposed on the inner layer of board 40a. Each of the plurality of second heat dissipators 51 is not electrically connected to first coil portion 49, but is electrically connected to second coil portion 57a.

Second heat dissipator 51 disposed on the first main surface of board 40a closer to first base portion 21a is connected to wiring pattern 54 of second coil portion 57a disposed on the first main surface. Second heat dissipator 51 disposed on the second main surface of board 40a closer to second base portion 22a is connected to wiring pattern 54 of second coil portion 57a disposed on the second main surface.

First lead-out portion 58a is a wiring pattern for a current flow to second coil portion 57a. First lead-out portion 58a is disposed on the first main surface of board 40a closer to first base portion 21a, is connected to wiring pattern 54 of second coil portion 57a disposed on the first main surface, and extends from wiring pattern 54 in the second orthogonal direction between second leg portion 24 and third leg portion 25. For example, first lead-out portion 58a may be disposed on the second main surface of board 40a closer to second base portion 22a, and may be connected to wiring pattern 54 disposed on the first main surface of board 40a closer to first base portion 21a via a via-conductor (not illustrated).

Second lead-out portion 59a is a wiring pattern for a current flow to second coil portion 57a. Second lead-out portion 59a is disposed on the second main surface of board 40a closer to second base portion 22a, is connected to wiring pattern 54 of second coil portion 57a disposed on the second main surface, and extends from wiring pattern 54 in the second orthogonal direction between second leg portion 24 and third leg portion 25. For example, second lead-out portion 59a may be disposed on the first main surface of board 40a closer to first base portion 21a, and may be connected to wiring pattern 54 disposed on the second main surface of board 40a closer to second base portion 22a via a via-conductor (not illustrated).

For example, a magnetic field can be generated by second coil portion 57a by causing current to flow from first lead-out portion 58a toward second lead-out portion 59a. For example, current may flow from second lead-out portion 59a to first lead-out portion 58a.

Heat transfer member 70a is disposed between board 40a and first base portion 21a. Specifically, heat transfer member 70a is disposed, for example, between second coil portion 57a and first base portion 21a. Heat transfer member 70a is a gap filler, and is disposed to fill the gap between board 40a and first base portion 21a.

In coil device 10a according to Embodiment 2, core 20a includes: fourth leg portion 36a that is disposed between first base portion 21a and second base portion 22a and between first leg portion 23 and third leg portion 25; and fifth leg portion 37a that is disposed between first base portion 21a and second base portion 22a and between first leg portion 23 and fourth leg portion 36a. Board 40a includes: fourth through-hole 55a through which fourth leg portion 36a is inserted; and fifth through-hole 56a through which fifth leg portion 37a is inserted. Third leg portion 25 includes two leg pieces 32 and 33 that are spaced apart in the second orthogonal direction to define second space 31 that is open toward fourth leg portion 36a. Wiring portion 44a includes: second coil portion 57a that surrounds fourth through-hole 55a; and second heat dissipater 51 that is positioned in second space 31 and is electrically connected to second coil portion 57a.

This enables the heat generated in second coil portion 57a to be dissipated via second heat dissipator 51 positioned in second space 31 and electrically connected to second coil portion 57a. Therefore, it is possible to efficiently dissipate the heat generated in second coil portion 57a, while reducing an increase in size of coil device 10a.

Moreover, in coil device 10a according to Embodiment 2, when coil device 10a is viewed from the opposing direction, a sum of an area of first leg portion 23 and an area of fourth leg portion 36a is greater than a sum of an area of second leg portion 24, an area of third leg portion 25, and an area of fifth leg portion 37a.

This makes the magnetic flux density of the magnetic field generated by first coil portion 49 and second coil portion 57a more uniform, while reducing an increase in size of coil device 10a.

### Embodiment 3

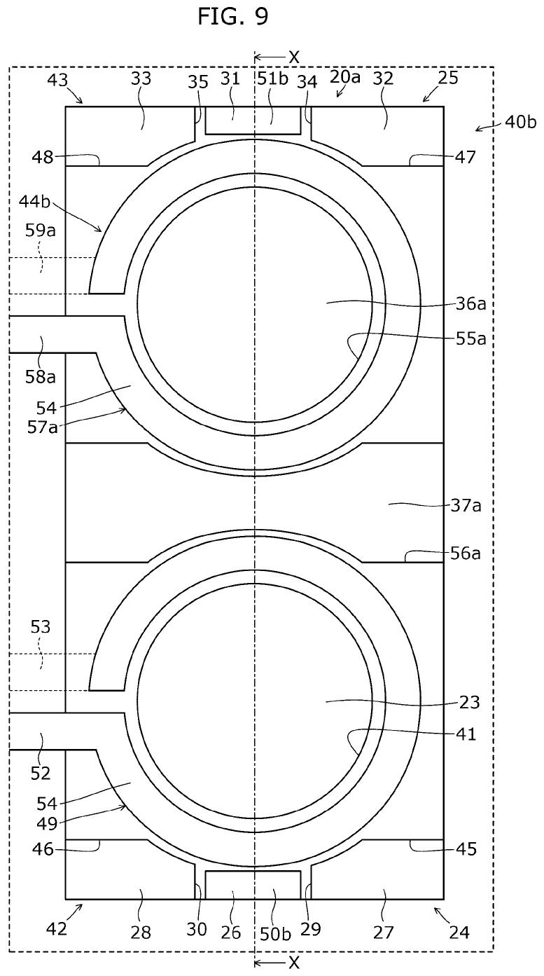

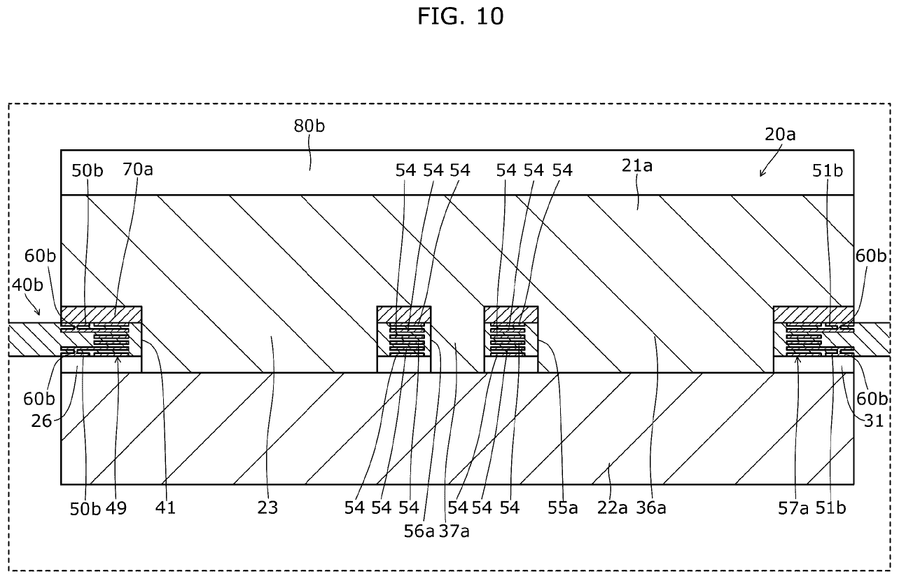

FIG. 9 is a plan view of a portion of a coil device according to Embodiment 3. FIG. 10 is a cross-sectional view taken along line X-X in FIG. 9.

As illustrated in FIG. 9 and FIG. 10, the coil device according to Embodiment 3 includes board 40b and heat dissipation member 80b. The differences from coil device 10a will be mainly described below.

Board 40b includes wiring portion 44b.

Wiring portion 44b includes a plurality of first heat dissipators 50b, a plurality of second heat dissipators 51b, and via-conductors 60b.

First heat dissipators 50b are disposed on a first main surface of board 40b closer to first base portion 21a, and are not connected to wiring pattern 54 disposed on the first main surface.

Moreover, first heat dissipators 50b are disposed on a second main surface of board 40b closer to second base portion 22a, and are not connected to wiring pattern 54 disposed on the second main surface.

First coil portion 49 includes a plurality of wiring patterns 54 on the inner layer of board 40b. First heat dissipator 50b disposed on the first main surface of board 40b closer to first base portion 21a is connected to wiring pattern 54 of first coil portion 49 disposed on the inner layer of board 40b via via-conductor 60b. First heat dissipator 50b disposed on the second main surface of board 40b closer to second base portion 22a is connected to, via via-conductor 60b, wiring pattern 54 of first coil portion 49 that is disposed on the inner layer of board 40b and is different from wiring pattern 54 to which first heat dissipator 50b disposed on the first main surface is connected.

Second coil portion 57a includes a plurality of wiring patterns 54 disposed on the inner layer of board 40b. Second heat dissipator 51b disposed on the first main surface of board 40b closer to first base portion 21a is connected to wiring pattern 54 of second coil portion 57a disposed on the inner layer of board 40b via via-conductor 60b. Second heat dissipator 51b that is disposed on the second main surface of board 40b closer to second base portion 22a is connected to, via via-conductor 60b, wiring pattern 54 of second coil portion 57a that is disposed on the inner layer of board 40b and is different from wiring pattern 54 to which second heat dissipator 51b disposed on the first main surface is connected.

Heat dissipation member 80b is disposed on first base portion 21a. For example, heat dissipation member 80b is a member that includes a metal housing in which a pipe for cooling water is disposed.

For example, heat dissipation member 80b may be disposed only on second base portion 22a, or on both first base portion 21a and second base portion 22a. Each of coil device 10 according to Embodiment 1 and coil device 10a according to Embodiment 2 may include such a heat dissipation member in a similar manner.

In the coil device according to Embodiment 3, first coil portion 49 includes wiring pattern 54 that is disposed on the inner layer of board 40b, and wiring portion 44b includes via-conductor 60b. First heat dissipator 50b is disposed on the main surface of board 40b closer to first board 21a, and is connected to wiring pattern 54 via via-conductor 60b.

This enables the heat generated in wiring pattern 54 disposed on the inner layer to be efficiently dissipated via first heat dissipator 50b. Therefore, it is possible to efficiently dissipate the heat generated in first coil portion 49, while reducing an increase in size of the coil device.

Moreover, the coil device according to Embodiment 3, further includes: heat dissipation member 80b that is disposed on first base portion 21a.

This enables the heat generated in first coil portion 49 to be more efficiently dissipated.

### Embodiment 4

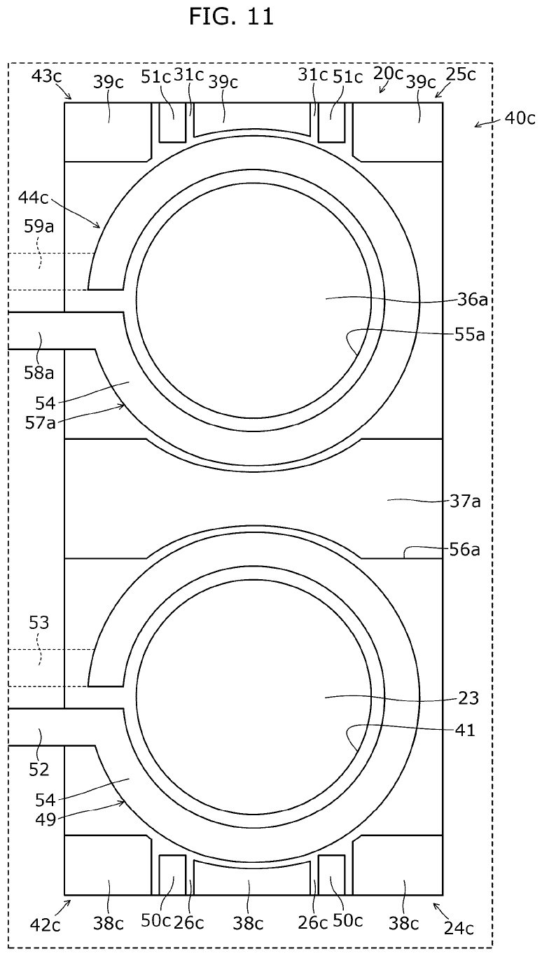

FIG. 11 is a plan view of a portion of a coil device according to Embodiment 4.

As illustrated in FIG. 11, the coil device according to Embodiment 4 includes core 20c and board 40c. The differences from the coil device according to Embodiment 3 will be mainly described below.

Core 20c includes second leg portion 24c and third leg portion 25c.

Second leg portion 24c includes three leg pieces 38c aligned in the second orthogonal direction. Two adjacent leg pieces 38c of three leg pieces 38c define first space 26c that is open toward first leg portion 23. In the present embodiment, two first spaces 26c that are aligned in the second orthogonal direction are provided.

Third leg portion 25c includes three leg pieces 39c aligned in the second orthogonal direction. Two adjacent leg pieces 39c of three leg pieces 39c define second space 31c that is open toward first leg portion 23. In the present embodiment, two second spaces 31c that are aligned in the second orthogonal direction are provided.

Board 40c includes second through-hole 42c, third through-hole 43c, and wiring portion 44c.

Wiring portion 44c includes a plurality of first heat dissipators 50c and a plurality of second heat dissipators 51c.

First heat dissipator 50c is disposed in each of two first spaces 26c on the first main surface of board 40c closer to first base portion 21a, and is not connected to wiring pattern 54 disposed on the first main surface. For example, first heat dissipator 50c may be disposed in each of two first spaces 26c on the second main surface of board 40c closer to second base portion 22a.

Second heat dissipator 51c is disposed in each of two second spaces 31c on a first main surface of board 40c closer to first base portion 21a, and is not connected to wiring pattern 54 disposed on the first main surface. For example, second heat dissipator 51c may be disposed in each of two second spaces 31c on a second main surface of board 40c closer to second base portion 22a.

First coil portion 49 includes a plurality of wiring patterns 54 disposed on the inner layer of board 40c. First heat dissipator 50c disposed in one first space 26c on the first main surface of board 40c closer to first base portion 21a is connected to wiring pattern 54 of first coil portion 49 disposed on the inner layer of board 40c via via-conductor 60b. First heat dissipator 50c disposed in the other first space 26c on the first main surface of board 40c closer to first base portion 21a is connected, via via-conductor 60b, to wiring pattern 54 of first coil portion 49 that is disposed on the inner layer of board 40c and is different from wiring pattern 54 to which first heat dissipator 50c disposed in one first space 26c is connected.

Second coil portion 57a includes a plurality of wiring patterns 54 disposed on the inner layer of board 40c. Second heat dissipator 51c disposed in one second space 31c on the first main surface of board 40c closer to first base portion 21a is connected to wiring pattern 54 of second coil portion 57a disposed on the inner layer of board 40c via via-conductor 60b. Second heat dissipator 51c disposed in the other second space 31c on the first main surface of board 40c closer to first base portion 21a is connected, via via-conductor 60b, to wiring pattern 54 of second coil portion 57a that is disposed on the inner layer of board 40c and is different from wiring pattern 54 to which second heat dissipator 51c disposed on one second space 31c is connected.

### EXAMPLES

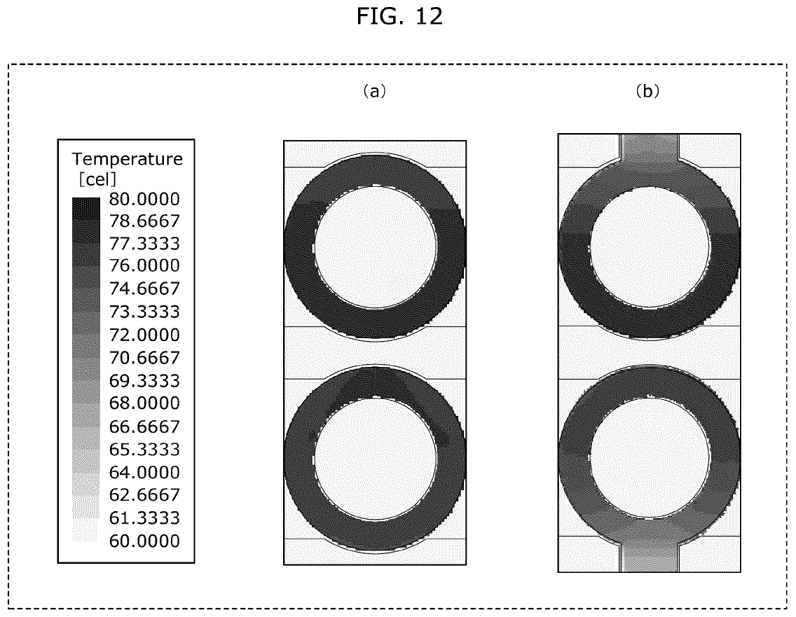

FIG. 12 illustrates a temperature of a coil device according to a comparative example and a temperature of a coil device according to Example 1. In FIG. 12, (a) illustrates the temperature of a wiring portion of the coil device according to the comparative example, and (b) illustrates the temperature of a wiring portion of the coil device according to Example 1.

The coil device according to Example 1 differs mainly from the coil device according to the comparative example in that the coil device according to Example 1 includes a first heat dissipator and a second heat dissipator.

As illustrated in FIG. 12, the temperature of the wiring portion of the coil device according to Example 1 is lower than the temperature of the wiring portion of the coil device according to the comparison example.

In such a manner, by providing the first heat dissipator and the second heat dissipator, the heat generated in the coil portion can be dissipated efficiently.

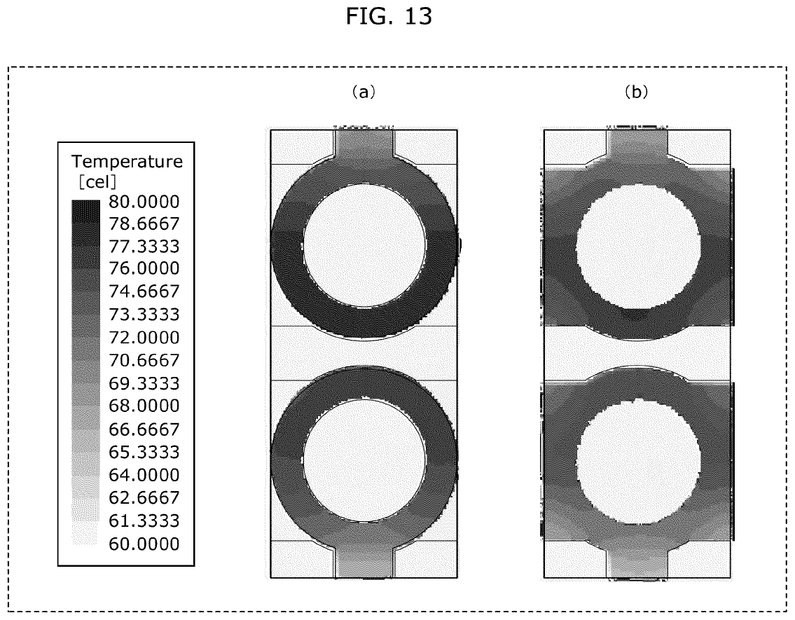

FIG. 13 illustrates a temperature of the coil device according to Example 1 and a temperature of a coil device according to Example 2. In FIG. 13, (a) illustrates the temperature of the wiring portion of the coil device according to Example 1, and (b) illustrates the temperature of a wiring portion of the coil device according to Example 2.

The coil device according to Example 2 differs mainly from the coil device according to Example 1 in that the area of the wiring portion in Example 2 is larger than the area of the coil device according to Example 1 in a plan view.

As illustrated in FIG. 13, the temperature of the wiring portion of the coil device according to Example 2 is lower than the temperature of the wiring portion of the coil device according to Example 1.

In such a manner, by increasing the area of the coil portion in a plan view, the heat generated in the coil portion can be dissipated efficiently.

### (Supplementary Notes)

Through the foregoing description of the embodiments and so forth, the following techniques are disclosed.

### (Technique 1)

A coil device including: a core that includes: a first base portion; a second base portion that is opposed to the first base portion; a first leg portion that is disposed between the first base portion and the second base portion; a second leg portion that is disposed between the first base portion and the second base portion, the second leg portion being disposed on a first side relative to the first leg portion in a first orthogonal direction that is orthogonal to an opposing direction in which the first base portion and the second base portion are opposed to each other; and a third leg portion that is disposed between the first base portion and the second base portion, the third leg portion being disposed on a second side relative to the first leg portion in the first orthogonal direction; and a board that includes: a first through-hole through which the first leg portion is inserted; a second through-hole through which the second leg portion is inserted; a third through-hole through which the third leg portion is inserted; and a wiring portion, wherein the second leg portion includes two leg pieces that are spaced apart in a second orthogonal direction to define a first space that is open toward the first leg portion, the second orthogonal direction being orthogonal to the opposing direction and the first orthogonal direction, and the wiring portion includes: a first coil portion that surrounds the first through-hole; and a first heat dissipator that is positioned in the first space and is electrically connected to the first coil portion.

### (Technique 2)

The coil device according to technique 1, including: a heat transfer member that is disposed between the first heat dissipator and the first base portion.

### (Technique 3)

The coil device according to technique 2, wherein the heat transfer member is a gap filler.

### (Technique 4)

The coil device according to any one of technique 1 to technique 3, wherein the first coil portion includes a wiring pattern that is disposed on a main surface of the board closer to the first base portion, and the first heat dissipator is disposed on the main surface, and is connected to the wiring pattern.

### (Technique 5)

The coil device according to any one of technique 1 to technique 3, wherein the first coil portion includes a wiring pattern that is disposed on an inner layer of the board, the wiring portion includes a via-conductor, and the first heat dissipator is disposed on a main surface of the board closer to the first base portion, and is connected to the wiring pattern via the via-conductor.

### (Technique 6)

The coil device according to any one of technique 1 to technique 5, wherein the third leg portion includes two leg pieces that are spaced apart in the second orthogonal direction to define a second space that is open toward the first leg portion, and the wiring portion includes a second heat dissipator that is positioned in the second space, the second heat dissipator being electrically connected to the first coil portion.

### (Technique 7)

The coil device according to any one of technique 1 to technique 6, wherein a shortest distance between the first leg portion and each of the two leg pieces of the second leg portion is equal to a shortest distance between the first leg portion and each of the two leg pieces of the third leg portion.

### (Technique 8)

The coil device according to any one of technique 1 to technique 5, wherein the core includes: a fourth leg portion that is disposed between the first base portion and the second base portion and between the first leg portion and the third leg portion; and a fifth leg portion that is disposed between the first base portion and the second base portion and between the first leg portion and the fourth leg portion, the board includes: a fourth through-hole through which the fourth leg portion is inserted; and a fifth through-hole through which the fifth leg portion is inserted, the third leg portion includes two leg pieces that are spaced apart in the second orthogonal direction to define a second space that is open toward the fourth leg portion, and the wiring portion includes: a second coil portion that surrounds the fourth through-hole; and a second heat dissipater that is positioned in the second space and is electrically connected to the second coil portion.

### (Technique 9)

The coil device according to technique 8, wherein, when the coil device is viewed from the opposing direction, a sum of an area of the first leg portion and an area of the fourth leg portion is greater than a sum of an area of the second leg portion, an area of the third leg portion, and an area of the fifth leg portion.

### (Technique 10)

The coil device according to any one of technique 1 to technique 9, further including: a heat dissipation member that is disposed on the first base portion.

### (Technique 11)

The coil device according to any one of technique 1 to technique 10, wherein, in the first orthogonal direction, a dimension of the first leg portion is greater than each of a dimension of the second leg portion and a dimension of the third leg portion.

### OTHER EMBODIMENTS

Although the coil device according to the present disclosure has been described above based on the embodiments above, the present disclosure is not limited to the embodiments.

In the embodiments described above, although the case has been described where first space 26 penetrates second leg portion 24, the present disclosure is not limited to such an example. For example, first space 26 does not have to penetrate second leg portion 24. For example, a member that connects the end portions of two leg pieces 27 and 28 opposite from first leg portion 23 may be provided, and first space 26 does not have to be open at the opposite side from first leg portion 23. The same also applies to first space 26c, second space 31, and second space 31c.

In the embodiments described above, although the case has been described where third leg portion 25 defines second space 31, the present disclosure is not limited to such an example. For example, third leg portion 25 does not have to define second space 31. In this case, for example, second heat dissipator 51 does not have to be included. The same also applies to third leg portion 25c.

In the embodiments described above, although the case has been described where heat transfer member 70 is disposed between board 40 and first base portion 21, the present disclosure is not limited to such an example. For example, heat transfer member 70 may be disposed only between board 40 and second base portion 22, or both between board 40 and first base portion 21 and between board 40 and second base portion 22. The same also applies to heat transfer member 70a.

In the embodiments described above, although the case has been described where coil device 10 includes heat transfer member 70, the present disclosure is not limited to such an example. For example, coil device 10 does not have to include heat transfer member 70. In this case, for example, board 40 is fixed to first leg portion 23, second leg portion 24, third leg portion 25, and the like by adhesive or the like. The same also applies to coil device 10a and the like.

The present disclosure includes other exemplary embodiments such as an exemplary embodiment that is obtained by making various modifications conceived by those skilled in the art to each exemplary embodiment described above, and an exemplary embodiment that is implemented by freely combining structural elements and functions in each exemplary embodiment without departing from the spirit of the present disclosure.

### INDUSTRIAL APPLICABILITY

The coil device according to the present disclosure is useful, for example, for devices that include coil portions.

### REFERENCE SIGNS LIST

10,10a coil device
20,20a, 20c core
21,21a first base portion
22,22a second base portion
23 first leg portion
24,24c second leg portion
25,25c third leg portion
26,26c first space
27,28,32,33,38c, 39c leg piece
29,30,34,35 face
31,31c second space
36a fourth leg portion
37a fifth leg portion
40,40a,40b,40c board
41 first through-hole
42,42c second through-hole
43,43c third through-hole
44,44a,44b,44c wiring portion
45,46,47,48 through-hole
49 first coil portion
50,50b,50c first heat dissipator
51,51b,51c second heat dissipator
52,58a first lead-out portion
53,59a second lead-out portion
54 wiring pattern
55a fourth through-hole
56a fifth through-hole
57a second coil portion
60b via-conductor
70,70a heat transfer member
80b heat dissipation member

1. A coil device comprising:
a core that includes:
a first base portion;
a second base portion that is opposed to the first base portion;
a first leg portion that is disposed between the first base portion and the second base portion;
a second leg portion that is disposed between the first base portion and the second base portion, the second leg portion being disposed on a first side relative to the first leg portion in a first orthogonal direction that is orthogonal to an opposing direction in which the first base portion and the second base portion are opposed to each other; and
a third leg portion that is disposed between the first base portion and the second base portion, the third leg portion being disposed on a second side relative to the first leg portion in the first orthogonal direction; and
a board that includes:
a first through-hole through which the first leg portion is inserted;
a second through-hole through which the second leg portion is inserted;
a third through-hole through which the third leg portion is inserted; and
a wiring portion,
wherein the second leg portion includes two leg pieces that are spaced apart in a second orthogonal direction to define a first space that is open toward the first leg portion, the second orthogonal direction being orthogonal to the opposing direction and the first orthogonal direction, and
the wiring portion includes:
a first coil portion that surrounds the first through-hole; and
a first heat dissipator that is positioned in the first space and is electrically connected to the first coil portion.

2. The coil device according to claim 1, comprising:
a heat transfer member that is disposed between the first heat dissipator and the first base portion.

3. The coil device according to claim 2,
wherein the heat transfer member is a gap filler.

4. The coil device according to claim 1,
wherein the first coil portion includes a wiring pattern that is disposed on a main surface of the board closer to the first base portion, and
the first heat dissipator is disposed on the main surface, and is connected to the wiring pattern.

5. The coil device according to claim 1,
wherein the first coil portion includes a wiring pattern that is disposed on an inner layer of the board,
the wiring portion includes a via-conductor, and
the first heat dissipator is disposed on a main surface of the board closer to the first base portion, and is connected to the wiring pattern via the via-conductor.

6. The coil device according to claim 1,
wherein the third leg portion includes two leg pieces that are spaced apart in the second orthogonal direction to define a second space that is open toward the first leg portion, and
the wiring portion includes a second heat dissipator that is positioned in the second space, the second heat dissipator being electrically connected to the first coil portion.

7. The coil device according to claim 6,
wherein a shortest distance between the first leg portion and each of the two leg pieces of the second leg portion is equal to a shortest distance between the first leg portion and each of the two leg pieces of the third leg portion.

8. The coil device according to claim 1,
wherein the core includes:
a fourth leg portion that is disposed between the first base portion and the second base portion and between the first leg portion and the third leg portion; and
a fifth leg portion that is disposed between the first base portion and the second base portion and between the first leg portion and the fourth leg portion,
the board includes:
a fourth through-hole through which the fourth leg portion is inserted; and
a fifth through-hole through which the fifth leg portion is inserted,
the third leg portion includes two leg pieces that are spaced apart in the second orthogonal direction to define a second space that is open toward the fourth leg portion, and
the wiring portion includes:
a second coil portion that surrounds the fourth through-hole; and
a second heat dissipater that is positioned in the second space and is electrically connected to the second coil portion.

9. The coil device according to claim 8,
wherein, when the coil device is viewed from the opposing direction, a sum of an area of the first leg portion and an area of the fourth leg portion is greater than a sum of an area of the second leg portion, an area of the third leg portion, and an area of the fifth leg portion.

10. The coil device according to claim 1, further comprising:
a heat dissipation member that is disposed on the first base portion.

11. The coil device according to claim 1,
wherein, in the first orthogonal direction, a dimension of the first leg portion is greater than each of a dimension of the second leg portion and a dimension of the third leg portion.
